(19) United States
(12) Patent Application Publication
(10) Pub. No.: US 2016/0117600 A1
(43) Pub. Date: Apr. 28, 2016

(54) Consistent Ordinal Reduced Error Logistic Regression Machine

(71) Applicant: Daniel M. Rice, Brentwood, MO (US)

(72) Inventor: Daniel M. Rice, Brentwood, MO (US)

(21) Appl. No.: 14/990,494

(22) Filed: Jan. 7, 2016

Related U.S. Application Data
(62) Division of application No. PCT/US14/46060, filed on Jul. 10, 2014.

(51) Int. Cl. G06N 7/00; G06N 99/00

(52) U.S. Cl. CPC G06N 7/005; G06N 99/005

(57) ABSTRACT

An invention in the form of a Consistent Reduced Error Logistic Regression (RELR) Machine method is detailed. This invention includes mechanisms to result in logically consistent, explicit and more reliable learning within the RELR method related to ordinal target outcomes.

### CROSS-REFERENCE TO RELATED APPLICATIONS

This application is a division of the non-provisional international application PCT/US14/46060 filed on Jul. 10, 2014, which will now be abandoned.

### STATEMENT REGARDING FEDERALLY SPONSORED RESEARCH

Not Applicable.

### BACKGROUND OF THE INVENTION

The present invention improves a previously patented machine learning method, Generalized Reduced Error Logistic Regression Method (RELR), which is U.S. Pat. No. 8,032,473, by the same inventor and is reviewed in a book by the inventor (D. M. Rice, Calculus of Thought: Neuromorphic Logistic Regression in Cognitive Machines, Waltham, Mass., Elsevier: Academic Press: 2014). The present invention improves the application and reliability of this previously patented RELR invention in fundamental ways that improve computer technology.

Inventions of mechanisms that enable learning and artificial intelligence in computers are as fundamental to the improvement of today's computing machines as are the invention of mechanisms that improve encryption, speed of operation, and ease of access. The field of study for learning and artificial intelligence in computers is generally called machine learning. While many machine learning methods like the RELR method have crude analogy to superficial aspects of neural learning, the reality is that the laws of nature that govern the mechanisms of neural learning are still not either generally or even partially agreed upon. So the human invention of a controllable and automated machine learning computational mechanism should not be viewed as an invention of a law of nature, as there is unlikely to be more than a superficial similarity in underlying mechanisms in cases like this even if and when nature's computation mechanisms in neural learning are understood and agreed upon by science. By analogy, airplanes were invented with an inspiration to mimic the flight capabilities of birds and are remotely similarly in that they both have wings and both ultimately fly, but the patenting of the flight control mechanisms of airplanes could hardly be the invention of a law of nature related to how birds fly as there is too much dissimilarity in underlying mechanisms.

Improved machine learning technology has fundamental, very useful application across most application areas of computing today in much the same way that technological innovation related to faster processing or more reliable encryption algorithms also would apply very generally to the fundamental improvement, usefulness and wider application of computers. Machine learning may be implemented in either software or hardware, although software allows the most flexible and general implementation and is the preferred mode.

The present invention is built upon the RELR machine learning method which is described in the U.S. Pat. No. 8,032,473, as that invention is still very useful and is the fundamental technology that led the way to the present invention. However, the present invention improves this basic RELR machine learning method that is the subject of the U.S. Pat. No. 8,032,473 to allow more accurate RELR machine learning method in specific cases involving learning of ordinal target outcomes. Ordinal target outcomes are defined to include any target variable for machine learning which has two or more ordered categories. This may include a target variable which has been categorized into a smaller set of ordinal categories based upon interval-categories of a continuous target variable. Necessary components of this invention include how to handle perfectly positive or negative correlations between predictor features and target variables and how to select explicit, parsimonious predictive features in this learning. While there are small changes in phraseology including correction of obvious typing mistakes necessary to amend the PCT/US14/46060 application into the present divisional application given the restriction notice in the PCT review of that application, there is no new technical subject matter in this application compared to the PCT application PCT/US14/46060. Instead, sections of that application related to describing the U.S. Pat. No. 8,032,473 invention briefly, Improved Ordinal Target Learning, Explicit Feature Selection Learning, and Handling of Perfect Positive or Negative Correlations are copied with few small changes in phraseology into the present Detailed Description of the Invention and encompass the core of this divisional application. However, aspects of the PCT/US14/46060 teaching that included subject matter and claims that are unrelated to this present application are not included here consistent with it being a division of that original PCT/US14/46060 application, as this present application is carved out of that PCT/US14/46060 application. Amended phraseology which describes the unity of this present invention is summarized in FIG. 1, though this figure introduces no new subject matter. This figure also highlights the specific improvements that have been made relative to the U.S. Pat. No. 8,032,473, which were all clearly listed components of the PCT/US14/46060 application from which the present application is divided.

The title of this application also has been changed to be Consistent Ordinal Reduced Error Logistic Machine to reflect the logical consistency attribute of the presently described learning machine in that it learns weights for predictor variables that are logically consistent across order reversals of values in ordinal target outcomes in the sense that these weights simply reverse in sign (see FIG. 2). The mechanism that is necessary to achieve the logical consistency attribute of this present invention was not known in prior art related to the Reduced Error Logistic Regression method including all disclosure in the U.S. Pat. No. 8,032,473, as the machine learning method disclosed in that U.S. Pat. No. 8,032,473 did not have this important attribute for more than two target outcome categories and the present invention is much more useful than the U.S. Pat. No. 8,032,473 invention for this reason. Without this property, the learning weights for the predictor variables are entirely an arbitrary function of the ordering of the ordinal values in the target outcome variable, and the estimates of the target outcome category probabilities do not reverse in a logically consistent way with reversals in ordering and greater than two target outcome categories in that U.S. Pat. No. 8,032,473 invention (see next paragraph). The U.S. Pat. No. 8,032,473 invention is still very useful in many other ways and including the case with just two target outcome categories where the learning is not arbitrary and shows appropriate learning with target outcome order reversals, but the present improved invention is needed for the ordinal target outcome learning with greater than two target outcome categories.

Estimated target category probabilities in the present improved ordinal target learning automatically adjust to be logically consistent with any ordinal target variable reversal in values and without regard to the number of target outcome categories. That is, with any reversal in the ordering of ordinal target category values, the same probability estimates are returned for the reversed ordering of target values. So if an ordinal target is ordered from 1-4 and then reversed from 4-1, the original probability estimate for 1 will now be returned for the category ordered as 4. This improvement is because there are now only two categories in the error modeling without any regard to the number of categories in the ordinal target outcome. But this improvement in the PCT application was not clear because there was an obvious typing mistake in the PCT/US14/46060 application which inadvertently typed j=1 to 2 instead of j=1 to C in the summation in Equation 1.4 which references the error modeling from the U.S. Pat. No. 8,032,473 invention which was Equation 4 in that application. That obvious typing mistake is now corrected, as Equation 1.4 in the present application is now an exact copy of Equation 4 from the U.S. Pat. No. 8,032,473. A requirement to attain this logical consistency is that only 2 categories are utilized in the error modeling and so j only should be allowed to equal 1 and 2, whereas the U.S. Pat. No. 8,032,473 allowed as many error categories as were target outcome categories or j=1 to C. So, the logical consistency aspect of the present invention which hinges on only having 2 error modeling categories of j=1 and j=2 which is shown through Equations 1.9, 1.10, 1.12, and 1.13 in this application has not been presented in any prior art which precedes the priority date of the PCT/US14/46060 application and the current application. Instead, this important logical consistency mechanism is novel to this invention.

The Explicit Feature Selection and Handling of Perfect Positive and Negative Correlations are aspects of this Consistent Ordinal Reduced Error Logistic Regression Machine, and so they are claimed as sub-components of this Consistent Ordinal Reduced Error Logistic Regression Machine and apply to ordinal target outcome learning with two or more categories. Along with the mechanism necessary to achieve logical consistency of ordered target outcome values in general, neither of these sub-components have been known through any prior art, and so the present invention in unity is very useful, novel and was not obvious to the present inventor who also invented the U.S. Pat. No. 8,032,473 invention. Note that some aspects of the section of the PCT/US14/46060 application which related to sequential learning were known in prior art through the U.S. Pat. No. 8,032,473 which claimed update learning of regression weights and so that section is not included in the present divisional application.

### BRIEF SUMMARY OF THE INVENTION

The present invention improves the RELR machine learning in the general case of ordinal target outcomes. This includes how to select very parsimonious features in this machine learning in what is here called Explicit RELR feature selection to differentiate it from the implicit feature reduction/selection taught in the U.S. Pat. No. 8,032,473. This also includes how to handle perfectly positive or negative correlations between predictive features and the target outcome in the learning.

### BRIEF DESCRIPTION OF THE DRAWINGS

FIG. 1 is a diagram of the overall invention;

FIG. 2 shows an example embodiment of this improved RELR method which learns based upon an ordinal target outcome with more than two category levels and where the weights in predictor variables (Variable 1 and 2) are simply reversed in sign when the ordering of the target outcomes is reversed.

FIG. 3 shows the convergence trajectory of the example embodiment of the Explicit RELR backward feature selection method; OLL, RLL, and ELL refer to log likelihood values explained in the detailed description.

FIG. 4 shows the remaining features at each step in the convergence trajectory of the example embodiment of the Explicit RELR method depicted in FIG. 3.

FIG. 5 shows the convergence trajectory of the control feature selection that has backward feature selection based upon χ2 that is used for comparison to the example embodiment of the Explicit RELR method; OLL, RLL, and ELL refer to log likelihood values explained in the detailed description.

FIG. 6 shows the remaining features at each step in the convergence trajectory of the χ2 backward selection depicted in FIG. 5.

FIG. 7 shows the optimization trajectory of training like the Explicit RELR embodiment in FIG. 3 and FIG. 4 in every way except an intercept is now added; OLL, RLL, and ELL refer to log likelihood values explained in the detailed description.

FIG. 8 shows the backward feature selection trajectory of this training in FIG. 7.

FIG. 9 shows the detailed computations in this Explicit RELR learning depicted in FIG. 3 and FIG. 4.

### DETAILED DESCRIPTION OF THE INVENTION

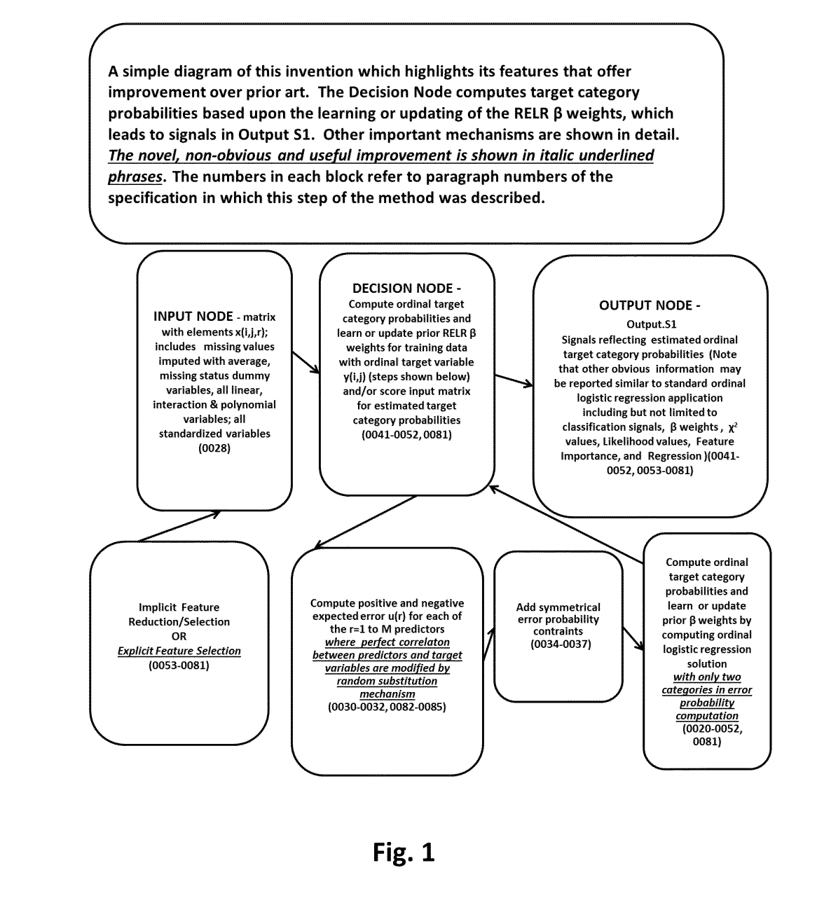

FIG. 1 depicts the present Ordinal RELR Machine Learning invention in all of its components. In order to understand the present improvements to the basic RELR machine learning method described in the U.S. Pat. No. 8,032,473, the basic RELR machine learning method first will be reviewed briefly here and then this specification will detail the improvement to that method to better handle learning related to ordinal target outcomes.

In order to understand the improvements to the basic RELR machine learning method, this already patented basic RELR machine learning method first will be briefly reviewed here. This already patented basic RELR machine learning method performs machine classification learning of target outcomes based upon a large number of features. This can be understood at a most fundamental mathematical level either through a maximum entropy formulation or a maximum likelihood formulation identical to Standard Logistic Regression in all regards except one. This is that RELR has a built-in automatic error probability learning mechanism, which accurately learns the probability of error events due to any potential source such as multicollinear, sampling error or overfitting error. Because of this automated error handling mechanism, RELR allows automated machine learning in situations where Standard Logistic Regression would be applied. But unlike Standard Logistic Regression, human users are not needed to perform manual analyses to check for error and overfitting problems in RELR The result is that RELR is an entirely automated machine computation method that removes the human user from the actual learning process. Additionally and because of this accurate error automatic error probability learning ability, RELR can be applied to very difficult high dimension and/or small sample problems where Standard Logistic Regression fails completely.

Just like Standard Logistic Regression, the maximum entropy and maximum likelihood RELR method disclosed in the U.S. Pat. No. 8,032,473 give equivalent results, but the maximum entropy machine learning is easier to understand where we seek to maximize:

$$H ( p , w ) = - {\sum }_{i = 1}^{N} {\sum }_{j = 1}^{C} {p}_{ij} ln ( {p}_{ij} ) - {\sum }_{l = 1 }^{2} {\sum }_{r = 1}^{M} {\sum }_{j = 1}^{2} {w}_{jlr} ln ( {w}_{jlr} ) \qquad ( 1.1 )$$

subject to constraints that include:

$$\begin{matrix}( {\sum }_{i = 1}^{N} {\sum }_{j = 1}^{C} ( {x}_{ir} {y}_{ij} ) ) + ( {u}_{r} {y}_{11 r} - {u}_{r} {y}_{12 r} ) + ( {u}_{r} {y}_{22 r} - {u}_{r} {y}_{21 r} ) = ( {\sum }_{i = 1}^{N} {\sum }_{j = 1}^{C} ( {x}_{ir} {p}_{ij} ) ) + ( {u}_{r} {w}_{11 r} - {u}_{r} {w}_{12 r} ) + ( {u}_{r} {w}_{22 r} - {u}_{r} {w}_{21 r} ) \\ for r = 1 to M , & ( 1.2 ) \\ {\sum }_{j = 1}^{C} {p}_{ij} = 1 for i = 1 to N , & ( 1.3 ) \\ {\sum }_{j = 1}^{C} {w}_{jlr} = 1 for l = 1 to 2 and r = 1 to M & ( 1.4 ) \\ {\sum }_{i = 1}^{N} {y}_{ij} = {\sum }_{i = 1}^{N} {p}_{ij} for j = 1 to C - 1. & ( 1.5 )\end{matrix}$$

where C is the number of target outcome categories which may also be choice alternatives in human tasks, N is the number of observations and M is the number of data feature constraints. The right hand summation in Equation (1.1) is the part containing error probability distribution w; the left hand summation in Equation (1.1) is the part containing the observation probability distribution p. Pseudo-observations are shown as the yⱼₗᵣ in the left hand side of Equation (1.2). They did not appear explicitly in the left hand side of that equation in the U.S. Pat. No. 8,032,473 because they cancel in the left hand side of Equation (1.2); the left hand side of this equation also shows real observations as reflected in the yᵢⱼ terms. In this formulation, yᵢⱼ=1 if the ith observation yields an outcome that is the jth possible category and 0 otherwise. Also, xᵢᵣ is the rth predictor variable feature associated with the ith observation where these features are standardized to have a mean of 0 and a standard deviation of 1. In addition to representing non-interactive features, interactions are possible where each interaction value is a product between xᵢᵣ values which are first standardized or a dummy coded missing value status indicator for each feature (see below). All derived effects including dummy coded binary features, dummy coded missing value features, interactions and nonlinear effects are always re-standardized once computed to have a mean of 0 and a standard deviation of 1. Hence, all features in RELR are scaled with this same standardized scaling. Each pᵢⱼ term is always positive and represents the probability that the ith observation yields the jth category as an outcome/choice and wⱼₗᵣ is also always positive and represents the probability of error across pseudo-observations that represent error events corresponding to the jth category and rth feature or moment and lth error sign (positive or negative) condition.

Other conventions are possible for the coding of pseudo-observations to learn error probabilities, along with the coding of the direction of error corresponding to the error probability terms wⱼₗᵣ, that give equivalent solutions. Yet, we use an easy to remember convention which is to let the pseudo-observations yⱼₗᵣ corresponding to the j=1 category equal 1 for both positive (l=1) and negative (l=2) error conditions across all r=1 to M features, where positive and negative error directions refer to the sign of the argument of the exponential function in the definition of the error probabilities as shown below for Equations (1.9), (1.10), (1.12), and (1.13). Thus, when l=1, a given wⱼₗᵣ term represents the probability of positive error, but when l=2, the wⱼₗᵣ term will represent the probability of negative error. The uᵣ term is a measure that estimates the expected error for the rth feature proportional to an inverse Student's t type statistic that does not assume separate variance measures for two binary outcome groups and that measures how reliably different Pearson correlations are from zero. It is defined as:

uᵣ=Ω/(rᵣ/{square root over (((1−rᵣ²)/Nᵣ)})) for r=1to M, where Ω is defined as: (1.5a)

$$Ω = 2 {\sum }_{r = 1}^{M} \vert {r}_{r} \vert / \sqrt{( ( 1 - {r}_{r}^{2} ) / {N}_{r} )} for r = 1 to M , \qquad ( 1.5 b )$$

and where Nᵣ>2, −1<rᵣ<1, and where rᵣ≠0.

where rᵣ represents the Pearson correlation between the rth feature and the target outcome variable across the Nᵣ non-missing observations. So, the part of Equation (1.5a) that is the denominator is a Student's type t-value that applies to Pearson correlations. In the case involving ordinal variables that have more than two levels whether they are independent or target variables, an obvious transformation is to use ranked values because Spearman correlations and Pearson correlations give equivalent results when ranked values are used. Ω is a positively valued scale factor that is the sum of the magnitude of the denominator of these t-values across all M features. This sum is multiplied by 2 because there are two values inversely proportional to t-values with identical magnitudes but opposite signs to learn the error probability for each feature.

The constraints given as Equation (1.5) are intercept constraints. The reason for the separate listing of intercept constraints is because RELR does not attempt to reduce error in intercept weights, as unlike the predictor variable features, there are no error probability terms wⱼₗᵣ corresponding to these intercept features.

In addition to the above, two additional sets of linear constraints are imposed in this RELR machine learning method described in the U.S. Pat. No. 8,032,473. These are constraints on the error probability distribution w:

$$\begin{matrix}{\sum }_{j = 1}^{2} {\sum }_{r = 1}^{M} {s}_{r} {w}_{j 1 r} - {\sum }_{r = 1}^{M} {s}_{r} {w}_{j 2 r} = 0 & ( 1.6 ) \\ {\sum }_{j = 1}^{2} {\sum }_{r = 1}^{M} {w}_{j 1 r} - {\sum }_{r = 1}^{M} {w}_{j 2 r} = 0 & ( 1.7 )\end{matrix}$$

where sᵣ is equal to 1 for the linear and cubic group of data constraints and −1 for the quadratic and quartic group of data constraints. Equation (1.6) forces the sum of the probabilities of error across the linear and cubic components to equal the sum of the probabilities of error across all the quadratic and quartic components. Equation (1.6) groups together the linear and cubic constraints that tend to correlate and matches them to quadratic and quartic components in likelihood of error. Equation (1.6) is akin to assuming that there is no inherent bias in the likelihood of positive vs. negative error in the linear and cubic components vs. the quadratic and quartic components. Equation (1.7) forces the sum of the probabilities of positive error across all M features to equal the sum of the probabilities of negative error across these same features.

As stated at the opening of this section, it is widely known that the maximum likelihood method in logistic regression produces an equivalent solution as this maximum entropy subject to constraints formulation with the objective function shown in Equation (1.1). In this equivalent formulation, standard maximum likelihood logistic regression is an unconstrained optimization problem where the log likelihood that results from the joint probability of all independent events that are learned is the objective to be maximized. In RELR, this objective contains probabilities of outcome events in real observations or pᵢⱼ terms and probabilities of error events in pseudo-observations or wⱼₗᵣ in direct analogy with the Equation (1.1) when all pᵢⱼ and wⱼₗᵣ terms are defined identically as the maximum entropy derivation gives as below. This gives the following log likelihood expression in RELR where again the right hand summation reflects the pseudo-observations:

$$LL ( p , w ) = {\sum }_{i = 1}^{N} {\sum }_{j = 1}^{C} y ( i , j ) ln ( p ( i , j ) ) + {\sum }_{l = 1}^{2} {\sum }_{j = 1}^{2} {\sum }_{r = 1}^{M} y ( l , j , r ) ln ( w ( l , j , r ) ) \qquad ( 1.1 a )$$

As with the constrained maximum entropy expression shown as Equation (1.1) and it associated constraints, the maximum of this equivalent expression shown in Equation (1.1a) can be solved through any methods widely used in machine learning that reliably lead to optimal solutions in such problems such as standard gradient ascent/descent optimization methods.

Improved Ordinal Target Learning

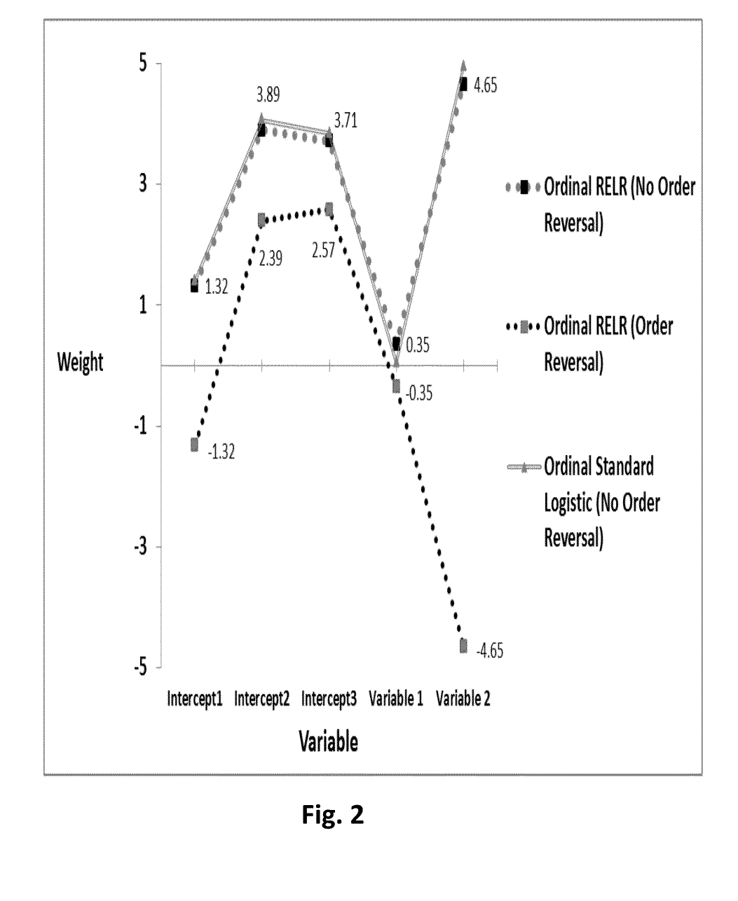

In the originally awarded U.S. Pat. No. 8,032,473, the error probability learning mechanism in the far right hand side of Equation (1.1) and all corresponding equations like Equations (1.6) and (1.7) had the outer summation across all C category outcomes. The present machine learning method gives identical solutions in the case of binary outcomes with only two ordinal outcomes, but only departs in actual practice in the case of more ordinal categories in the target variable. In the case of ordinal outcomes, the j=1 to 2 for example in Equations (1.6) and (1.7) categories now simply refer to error probability learning categories and do not mean actual ordinal categories. This change has the effect that the error probability learning for Ordinal RELR is no different from that used in Binary RELR. The reason for the change is that practical experience suggested problems with the original approach in that the ordering of the values of the target outcome relative to the reference condition was arbitrary and could strongly affect the error probability learning when the direction of the coding was reversed so that the previous highest ordinal category became the lowest ordinal category. With just two categories in the error probability learning as is used in Binary RELR and any number larger than two in the target outcome categories, the reversal flipping of the order has no effect now (see example embodiment in FIG. 2 and description below). In the previously awarded U.S. Pat. No. 8,032,473, only in the case of target outcomes with only two categories as in Binary RELR or ordinal or nominal target outcomes with two categories did reversal flipping have no effect, as there were only two categories also then in the error probability learning.

The presentation of this improved machine learning method departs from the previously awarded U.S. Pat. No. 8,032,473 which specifically showed the x feature having i, j, and r indexes for the purposes of ordinal RELR. This is simplified here to just have the i and r indexes when examples are on the case where there are two ordinal target categories. In a case of more than two ordinal categories, obviously the rth value of the feature x at the ith observation should vary across the ordinal category values as shown below. This variation is introduced in Equations below which is consistent with textbook presentations like Hosmer and Lemeshow by imposing the (C−j) and (C−k) multipliers. The ordinal RELR machine learning method is based upon proportional odds ordinal logistic regression as reviewed in standard logistic regression texts like Hosmer and Lemeshow (David W. Hosmer and Stanley Lemeshow. Applied Logistic Regression, New York: Wiley, 2000). However, the error probability learning in the present Ordinal RELR machine learning method is not a component of that standard proportional odds ordinal logistic regression.

This maximum entropy subject to constraints solution is found through the standard constrained optimization method which implies setting up a Lagrangian multiplier system and then solving for the optimal solution through a gradient ascent method for example. The probability components that are of interest in the solutions have the form:

$$\begin{matrix}{p}_{ij} = exp ( {α}_{j} + {\sum }_{r = 1}^{M} ( C - j ) {β}_{r} {x}_{ir} ) / ( 1 + {\sum }_{k = 1}^{C - 1} exp ( {α}_{k} + {\sum }_{r = 1}^{M} ( C - k ) {β}_{r} {x}_{ir} ) ) \\ for i = 1 to N and j = 1 to C - 1 , & ( 1.8 ) \\ {w}_{j 1 r} = exp ( {β}_{r} {u}_{r} + λ + {s}_{r} τ ) / ( 1 + exp ( {β}_{r} {u}_{r} + λ + {s}_{r} τ ) ) \\ for r = 1 to M and j = 1 , & ( 1.9 ) \\ {w}_{j 2 r} = exp ( - {β}_{r} {u}_{r} - λ - {s}_{r} τ ) / ( 1 + exp ( - {β}_{r} {u}_{r} - λ - {s}_{r} τ ) ) \\ for r = 1 to M and j = 1. & ( 1.10 ) \\ {p}_{ij} = 1 / ( 1 + {\sum }_{k = 1}^{C - 1} exp ( {α}_{k} + {\sum }_{r = 1}^{M} ( C - k ) {β}_{r} {x}_{ir} ) ) \\ for i = 1 to N and j = C , which is the reference . & ( 1.11 ) \\ {w}_{j 1 r} = 1 / ( 1 + exp ( {β}_{r} {u}_{r} + λ + {s}_{r} τ ) ) \\ for r = 1 to M and j = 2 , & ( 1.12 ) \\ {w}_{j 2 r} = 1 / ( 1 + exp ( - {β}_{r} {u}_{r} - λ - {s}_{r} τ ) ) \\ for r = 1 to M and j = 2. & ( 1.13 )\end{matrix}$$

Note that α terms that that are indexed as k=1 to C−1 and j=1 to C−1 are intercept weights. As noted above, obviously the feature x should be also indexed by the category indicator j or k in the case of Ordinal RELR so that it is multiplied by a value related or inversely related (depending upon the ordinal coding direction) to that category number or a value of 0 for the reference number in the probability definitions. This multiplication factor is now substituted into these probability definition equations to give a correct definition for Ordinal RELR that is equivalent to explicitly having each feature defined by xᵢᵣ to vary across ordinal categories.

FIG. 2 shows an example embodiment of Ordinal RELR, which is based upon simulation data with a sample size of 188 and four almost but not exactly equal ordinal categories in terms of observations, along with two predictor variables labeled as Variable 1 and Variable2. The overall pattern of the intercepts still changed when the order is reversed, but this is also what occurs in Standard Logistic Ordinal RELR (though reversal is not shown so as not to clutter the figure). Yet, importantly the predictor variable weights (Variable 1 and Variable 2) are mirror image sign reversals of each other, which is also what occurs in Standard Ordinal Logistic Regression. Likewise, the probability predictions for categories ordered as 1-4 are identical to these categories when their numerical order is reversed and they are coded as 4-1, so this improved Ordinal RELR machine learning method now has the desired property of being invariant to order reversal in its probability predictions, which is also exactly what is seen in Standard Ordinal Logistic Regression and what occurred in the original RELR method with only two target outcome categories as in a binary target outcome. FIG. 2 shows Standard Ordinal Logistic Regression (non-reversed) where predictor variable weights for Variable 1 and Variable 2 are 0.05 and 4.95. In that same FIG. 2, Ordinal RELR is seen to have another desired property in that it gives predictor variable weights for Variable 1 and Variable 2 that are closer to each other (0.35 and 4.65) and thus should be more stable, which is expected given RELR's error probability learning here which is known to reduce variability in logistic regression weights (Calculus of Thought: Neuromorphic Logistic Regression in Cognitive Machines, Waltham, Mass., Elsevier: Academic Press: 2014). Note also the RELR's error probability learning is not actually shrinking regression coefficient magnitudes which would cause the magnitude of all regression weights to decrease, but instead it is decreasing the variability of this regression weight magnitude across predictor variables which has the effect of actually slightly increasing the very small magnitude weight of Variable 1 in this case compared to Standard Logistic Regression in FIG. 2.

Parsimonious, Explicit Feature Selection Learning

Since RELR's machine learning is just based upon maximizing Equation (1.1a), it generates a maximum likelihood solution which is very straightforward to generate as long as one has chosen appropriate features which are the independent variable feature constraints. But it is rarely the case that one knows which predictive features should be chosen in advance in machine learning. In the U.S. Pat. No. 8,032,473 awarded patent, feature reduction/selection occurs by dropping from the larger initial candidate set the features with the lowest magnitude t values defined from the error probability learning in odd and even polynomial feature groups separately. This originally patented RELR feature reduction/feature selection method is now called Implicit RELR, and Implicit RELR also refers to the initial solution when there is no feature reduction/selection. Implicit RELR has good predictive accuracy and stability and is very rapid because this feature reduction/selection can be implemented as a largely parallel processing routine, but its solutions are still usually only implicit in the sense that they are not parsimonious enough to allow explicit interpretation. So while the previously patented feature reduction/selection based upon magnitude of t values is still very useful for problems where good and rapid prediction is all that is required, a different Explicit RELR mechanism is needed to give stable parsimonious interpretable final learning that may be useful to guide causal hypotheses for example.

In order to implement feature reduction/selection as a machine learning mechanism in RELR, some measure of the likelihood of learning given the feature selection may be used to grade different possible selections and select that feature set which is estimated to have the highest grade across all relevant feature selections. An obvious choice for a measure that reflects how likely a chosen feature set would be is a log likelihood measure since the likelihood is equivalent to the joint probability of all learned events, so the maximum likelihood, or equivalently maximum log likelihood, would be expected to reflect the maximal joint probability of all learned events predicted by the chosen feature set provided that all events are independent. Yet, in RELR there are actually different log likelihood measures to consider which do have quite different properties. This is suggested by the form of Equation (1.1a) above which defined the RELR log likelihood function which can be written as:

RLL=OLL+ET (1.14)

where RLL is the RELR log likelihood, OLL is the first set of summations on the right of Equation (1.1a) which is the observation log likelihood and ELL is the error log likelihood which is the second set of summations on the right of Equation (1.1a). In RELR, since the maximal RLL solution is the solution associated with the best fit to the observation and error probability learning with known predictor variable feature constraints, it is reasonable to expect that the RLL measure also could be useful to choose an optimal set of predictor variable feature constraints. RLL is different from the log likelihood in standard logistic regression in one important sense. Unlike the maximum log likelihood solution in standard logistic regression, the maximum RLL solution across all possible predictor variable feature sets is almost never observed when all candidate features are selected in training. Instead, this RLL value almost always reaches a maximum when learning is applied to a smaller subset of features. This is because each time that an predictor variable feature is dropped in RELR, two pseudo-observations corresponding to the positive and negative error event probability estimates for that feature are also dropped as described in the previously awarded patent. The dropping of the pseudo-observations in RELR causes a larger value of ELL when relearning is performed with the remain features and pseudo-observations. For this reason, as features are dropped and associated pseudo-observations are dropped, RELR will tend to generate a larger RLL solution for all relearning corresponding to remaining features and pseudo-observations until the remaining feature set is so small that it under-fits the data. Therefore in RELR, a better fit gives a larger or less negative OLL value which implies a better fit to the training data, whereas fewer predictor variable features give fewer pseudo-observations and a larger or less negative ELL. So RLL is maximal when an predictor variable feature set is chosen which gives both a relatively good fit to the training data and which does not utilize a relatively large number of predictor variable features which is exactly what is desired for Explicit RELR learning.

Thus, there are actually two log likelihood components in RELR to consider in terms of being able to guide optimal feature reduction/selection. First, there is just the portion which reflects the observation log likelihood or OLL which only measures goodness of fit to the training data. OLL tends to be maximal and least negative in solutions with a very good relative fit, but these are often very complex solutions that are not parsimonious. Second, there is the RELR log likelihood value or RLL which represents the sum of two components: the observation log likelihood known as OLL and the error log likelihood known as ELL The maximum of RLL is the optimal solution which gives both a good fit and which also returns parsimonious feature learning. The previously patented U.S. Pat. No. 8,032,473 US utility patent described how feature reduction/selection could be performed with a solution that estimated the maximum of the OLL objective given all considered feature sets in what is now called Implicit RELR. This section will describe how to perform parsimonious Explicit RELR feature reduction/selection based upon stable estimates of the maximum of the RLL objective across all considered feature sets.

When there are a large number of original features in relation to the number of observations, Explicit RELR proceeds in a first stage mechanism identical to that first stage mechanism used in Implicit RELR. This is a brute force method that just picks the smaller set of features from the larger candidate set which have the largest t value magnitudes used in the error probability learning just like the previously patented Implicit RELR front end feature reduction mechanism. Just as in Implicit RELR, when nonlinear features are considered as candidate features, the dropping of features is based upon the lowest magnitude t-values in odd and even polynomial features separately so as not to bias the solutions to favor odd vs. even polynomial terms.

Initially, a candidate set is identified based upon t-value magnitudes using the same initial feature reduction process as in Implicit RELR as described in the previously awarded patent. Once this done, Explicit RELR simply drops one feature at a time from this larger candidate set and iteratively refits the probability learning at each step. Amongst all such feature learning, the feature learning with the largest RLL value is chosen as the best feature learning. The feature which is dropped at each step is the least important feature, where importance is now defined differently from Implicit RELR. Here in the feature selection phase of Explicit RELR, importance is defined in terms of how sensitive the χ² measure associated with a feature effect is to a change in the stability s of the regression coefficient, where stability or s is the inverse standard error 1/se of the regression coefficient for the feature. That is, for each feature in the set of remaining candidate features, we seek the first derivative of χ² with respect to the stability s of the regression coefficient for the same feature, and view the feature which has the derivative with the least magnitude to represent the least important feature. Here we define χ² in terms of the Wald relationship that is widely known to approximate in standard logistic regression in large samples the likelihood ratio test measure that defines the effect of dropping a given feature where:

$${χ}_{r}^{2} = {( \frac{{β}_{r}}{{se}_{r}} )}^{2} \qquad ( 1.15 )$$

for all r=1 to M features in a probability learning where βᵣ is the regression coefficient for that feature and seᵣ is the standard error of the regression coefficient. Using simple rules from elementary calculus, the magnitude of this derivative can be defined to be:

$$\vert \frac{d {χ}_{r}^{2}}{d ( {s}_{r} )} \vert = \vert 2 {χ}_{r} {β}_{r} \vert \qquad ( 1.16 )$$

for each of the r=1 to M features that remain as candidates in the Explicit RELR backward selection at a given iteration. Because of RELR's error probability learning which generates stable probability learnings in very small samples, RELR mimics standard logistic regression's large sample behavior of this Wald relationship even in small samples (D. M. Rice, Calculus of Thought: Neuromorphic Logistic Regression in Cognitive Machines, Waltham, Mass., Elsevier: Academic Press: 2014).

The χ² value for an effect measures how reliably different from zero a regression coefficient might be, whereas stability or s measures how representative the regression coefficient resulting from the training sample will be of a value seen in the larger population. So, both of these measures should be involved in a measure of feature importance. A very important feature with a very large χ² value and with regression coefficient stability value s that approaches infinity would be very sensitive to even a small change in stability. On the other hand, a very unimportant feature with a very small χ² value with regression coefficient stability value s that approaches zero would change very little with a small change in stability. Thus, the magnitude of the derivative of χ² with respect to s or stability has face validity as a measure of feature importance.

Recall that RELR regression coefficients are always standardized regression coefficients, as all features are always standardized with a standard deviation of 1 and a mean of 0. Hence, when selected RELR features have similar χ² effects in high dimension situations, this necessarily implies that the standard error of the regression coefficient se is similarly almost proportional to the standardized regression coefficients across features given the Wald relationship. In other words, features with small magnitude regression coefficients will have small standard errors in these regression coefficient estimates, whereas features with larger magnitude regression coefficients will have larger standard errors in these estimates. The standard errors se here are an estimate of the standard deviation in the sampling distribution of β values for a given feature across independent samples. Because each feature's β is expected to be proportional to the error probability learning's t values in high dimension probability learnings in RELR as described in the previously awarded U.S. Pat. No. 8,032,473, it also makes sense that there also should be a correlation between β and its standard error se across features and that the magnitude of χ² should be similar across features in these high dimension cases given the Wald relationship.

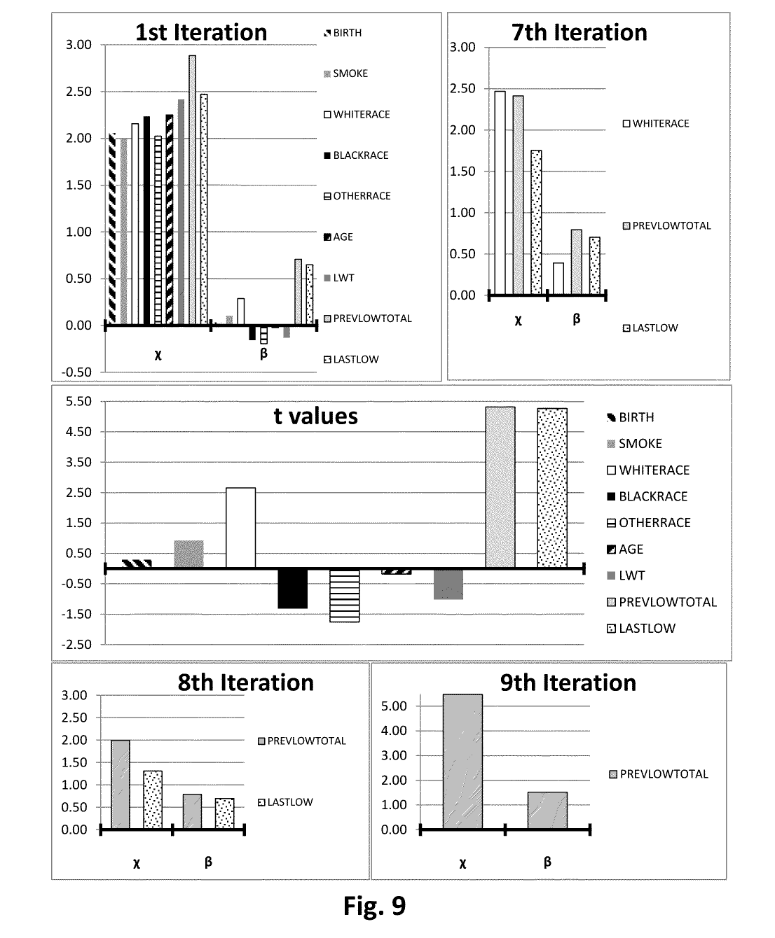

So unlike the error probability learning's t value magnitude for features, the χ² measure shows substantially low variability in high dimension and/or small samples across all features in RELR. Because of this, χ² provides relatively poor feature importance discrimination information. In fact as shown in Equation (1.16) Explicit RELR's feature importance measure is actually based upon the product of χ (the square root of χ²) and the regression coefficient β for each given feature. So we know that t and β are highly correlated in higher dimension RELR solutions when odd and even polynomial features are considered separately as shown in the U.S. Pat. No. 8,032,473 and we know that χ² values are roughly constant across these same high dimension features. Because of this, reducing a high dimension feature set by using the error probability's t value magnitudes excludes those features that also would be deemed relatively unimportant in the Explicit RELR selection which is simply a product of the relatively constant χ value and the more variable β value which has t as its proxy for each feature. At least, this can be expected to be true until the selected feature set has low enough dimension that the χ values begin to show more variability across features. An example of these patterns is in the Explicit RELR embodiment described below, but which has the details of these β, t, and χ parameters shown in FIG. 9. In this embodiment, almost proportional relationships between β and t even occur in the original nine features as the middle row shows the t values across those features. In addition, χ value magnitudes across features have much lower percentage variability than t or β magnitudes here. So, relatively low variability especially in relation to β is seen in χ even with only nine predictor variable features. Much less variability within odd and even polynomial groups is seen with larger feature sets.

In the best practice, care always must be taken by a human user to start the Explicit RELR solution with a large enough set of candidate features so that χ shows this low variability across features and the probability learning is not biased by where the feature selection starts which can be determined empirically. Additionally, χ may show variability across even vs. odd polynomial effect features, so the reduced feature set for Explicit RELR has to be started with a large enough set of features so that this variability does not affect the ultimate solution. Yet, this choice of the size of the reduced feature set is an arbitrarily large choice that will give reliable solutions that do not depend on this precise parameter choice if the human user errors on the side of too many starting candidate features. Best practice experience to date suggests that with a liberal parameter such as at least many hundred features, the only cost will be that the computation will take more time.

By removing the feature with the smallest rate of change in χ² per change in the stability s of the regression coefficient at each step, a slowest and most stable possible trajectory is discovered in this Explicit RELR ascent to the maximum RLL that we can estimate where we also drop each feature's pseudo-observations at each step. This slowest and most stable possible trajectory ensures that the maximum possible steps are taken before the maximal RLL across all steps is found which means that the most features and corresponding pseudo-observations are dropped which implies that it is parsimonious feature learning. This maximal RLL value is relatively stable by virtue of this slowest and most stable ascent that does take into stability in a definition of feature importance. So it would be expected to be predictive of feature learning that has good parsimony, along with good predictive accuracy in representative samples that are different from the training data. These good parsimony, stability and predictive accuracy characteristics are suggested by the following example embodiments.

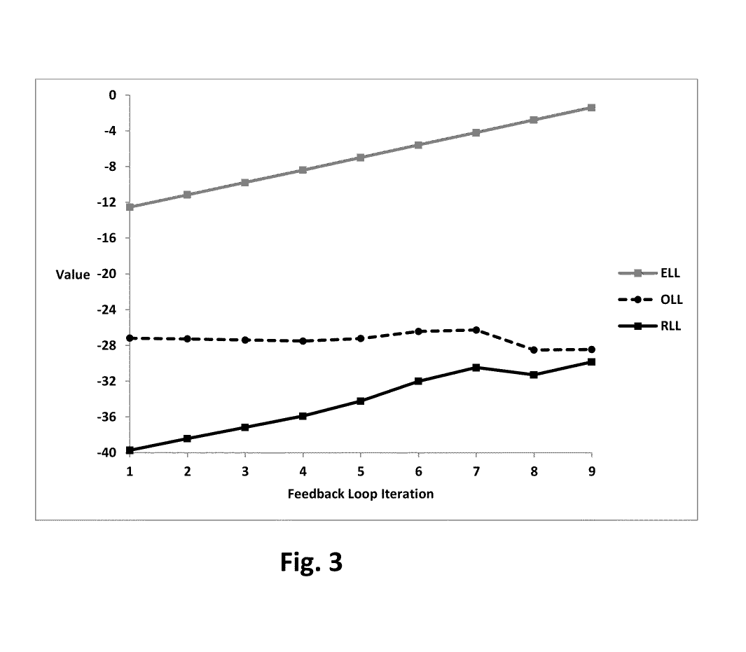

FIG. 3 shows trajectories of the total RELR log likelihood RLL, the error log likelihood ELL and the observation log likelihood OLL in Explicit RELR feature selection learning based upon a Low Birth Weight dataset, along with corresponding feature weights at each iteration step. This Low Birth Weight dataset is a widely used standard logistic regression dataset developed by Hosmer and Lemeshow and available online at http://www.umass.edu/statdata/statdata/data/. The target outcome is whether a low birth weight pregnancy was observed or not. A balanced stratified cross-sectional sample of 56 observations was randomly selected from this larger dataset to result in the training sample here. This sample was selected from the next to last cross-sectional sample in that dataset, as the last cross-sectional sample was used for out-of-time testing of a putative causal effect as reported later here. The exemplary training results presented here also do not contain any prior offset features, nonlinear features or interaction features just so to be very simple. An intercept feature was also excluded here.

In this Explicit RELR feature selection shown in FIG. 3, the OLL value is stable across this entire trajectory. This Explicit RELR feature selection returned only one predictor variable feature which was PREVLOWTOTAL in its maximal RLL solution at the 9th iteration. More generally, as Explicit RELR drops features the OLL value may also begin to drop substantially as less accuracy is attained. In such a case, the maximal RLL value across all iterations will occur with more features than just the one feature in this example. Yet, the basic trajectory pattern will be the same as shown in FIG. 3 as the slowest and most stable possible trajectory to reach the maximal RLL in this trajectory will make it likely that the most possible features are dropped prior to reaching the maximum. Note that there was actually a local maximum in this particular trajectory at the 7th iteration. FIG. 9 shows the detailed computations in this Explicit RELR learning, where various parameters like t, β and χ may be viewed at each step.

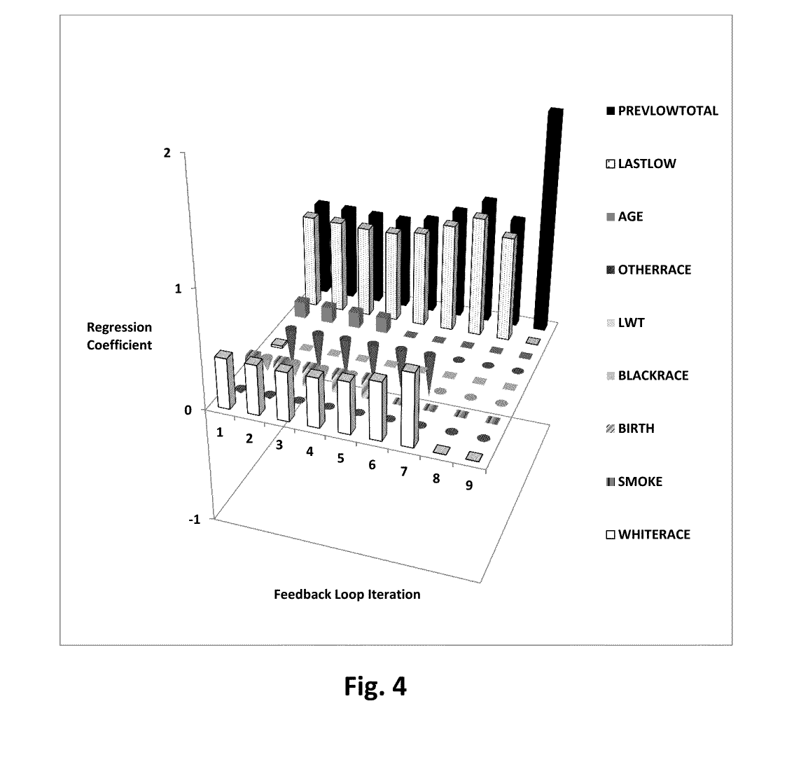

As apparent in FIG. 4 early in the Explicit RELR trajectory features that are dropped have almost no effect on future feature weights, so this is a very stable process. Only later in the process when important highly collinear features are dropped are there large changes in remaining features' weights. For example, the PREVLOWTOTAL feature reflects the total number of previous low birth weight pregnancies, whereas the LASTLOW feature reflects whether the last pregnancy had a low birth weight. These two features were correlated with one another roughly 0.9 across observations in this training sample and both were kept in the Explicit RELR feature set until the very last iteration. The OTHERRACE and WHITERACE were also kept in the feature set until late in the process. Note that because RELR is able to handle extreme multicollinearity, it dummy codes all levels of a categorical variable like Race and actually learns each as a separate standardized feature. This is unlike how standard logistic regression usually handles categorical variables and why WHITERACE, BLACKRACE and OTHERRACE are shown as distinct features. The benefits of learning all such levels are that an effect can be estimated for any particular level of a categorical variable.

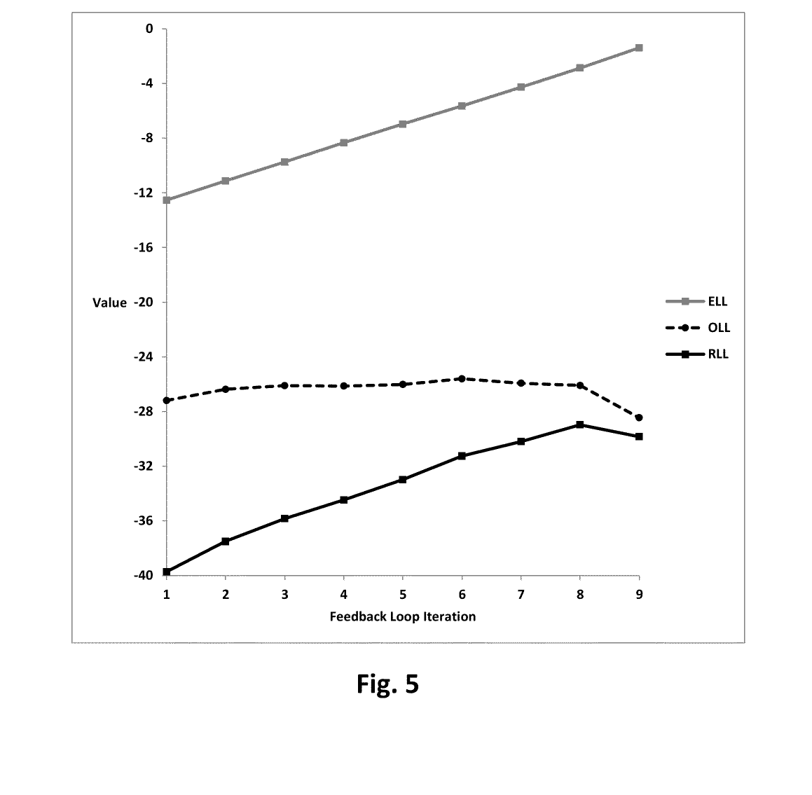

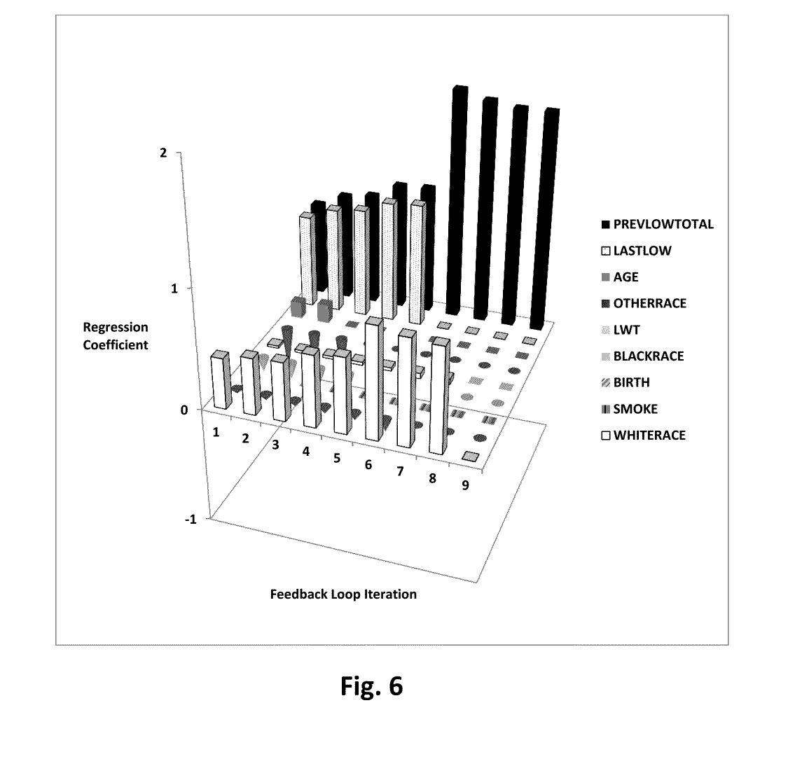

It was not possible to compute standard logistic regression for comparison here as standard logistic regression did not converge with such highly multicollinear features like PREVLOWTOTAL and LASTLOW. But, it was possible to compare to RELR where the least important feature is now dropped based upon χ² as is typically done in standard logistic regression backward selection. FIG. 5 and FIG. 6 show how this feature selection proceeded with the identical training data where χ² is now used to measure feature importance rather than Explicit RELR's magnitude of the χ² derivative. In all other ways, the procedures for the learning shown in FIG. 5 and FIG. 6 were identical to the Explicit RELR learning shown in FIG. 3 and FIG. 4 including the identical RELR error probability learning. FIG. 5 and FIG. 6 show that this χ² measure of importance produces a different learning compared with that shown in FIG. 3 and FIG. 4. This maximal RLL value now occurs at the 8th iteration and the corresponding learning includes both WHITERACE and PREVLOWTOTAL as features. Even in this simple example embodiment learning with only nine original features, it is apparent that the regression coefficients in FIG. 6 are less stable at earlier steps like across the 5^{th} and 6^{th} iterations compared to Explicit RELR in FIG. 4. In fact, Explicit RELR's selection from FIG. 3 also had a significantly larger RLL value than the selection based upon χ² in an independent cross-sectional hold out sample with 60 balanced observations (−38.67 vs. −42.10, p<0.05). So as predicted, Explicit RELR generates a larger RLL which reflects a more accurate learning with fewer features in an independent representative sample compared to selection based upon χ². It should be noted that Explicit RELR may not always generate a larger within-training sample RLL value compared to arbitrary methods to select features, especially in a very small training sample like in this example where Explicit RELR's RLL value was actually marginally less (−29.89 vs. −28.97). However, Explicit RELR still generalized better to a new independent representative hold out sample than the arbitrary selection based upon χ², so it shows less overfitting which typically implies better stability. So, in summary this example embodiment is evidence that Explicit RELR does provide feature selections that have relatively good predictive accuracy, parsimony and stability.

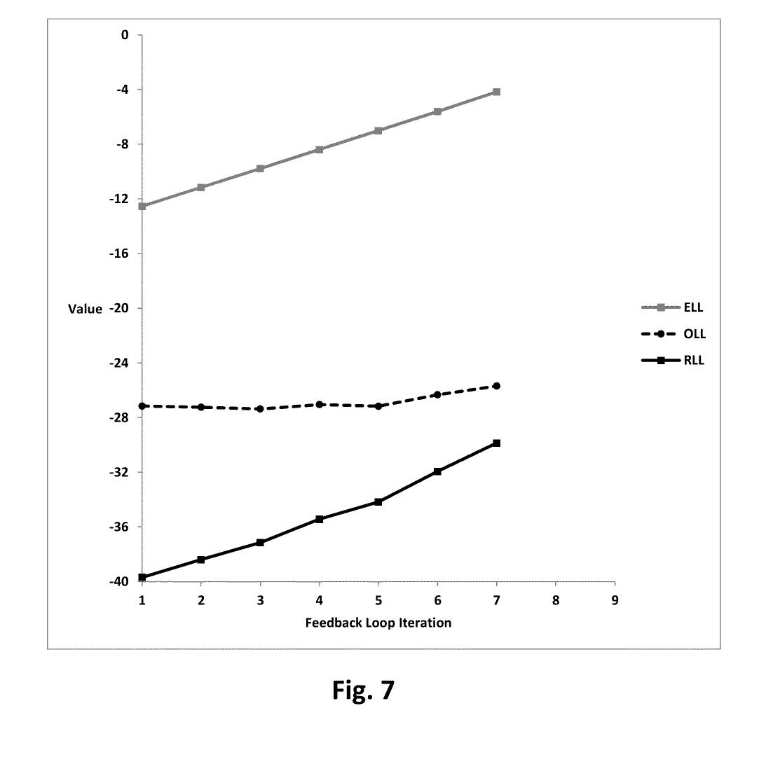

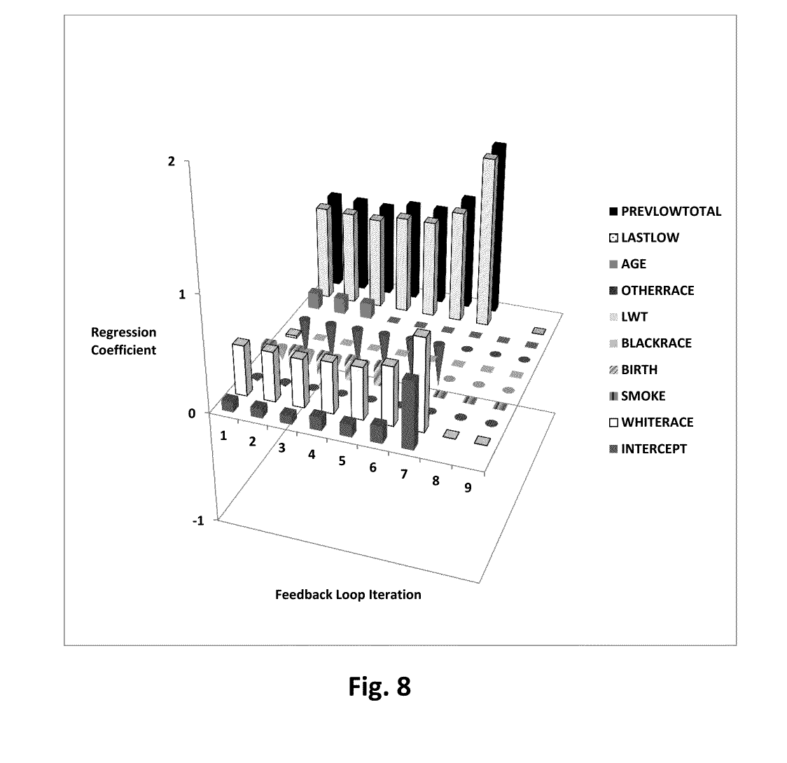

The recommended utilization of RELR in the case of an ordinal target variable with just two categories is to exclude/zero the intercept during the training in a sample that is stratified to be composed of an equal balance of target and non-target outcomes and then perform intercept correction as a post-training step to correct for such stratification. Intercept correction for stratified samples is a fairly common method in standard logistic regression, (see for example King, Gary, and Langche Zeng. 2001. Logistic Regression in Rare Events Data. Political Analysis 9: 137-163 as an example of intercept correction). In the case of Explicit RELR where stable, parsimonious and interpretable feature selections are the end goal, this exclusion of the intercept during training in balanced stratified samples is required to ensure generally stable solutions that converge and that do not depend upon how t values are computed in terms of variance assumptions related to the target vs. non-target groups in the target variable. The effect of including the intercept in perfectly balanced binary targets is shown in FIG. 7 and FIG. 8 where we now put it back it in training that is otherwise exactly the same as the example embodiment that was depicted as FIG. 3 and FIG. 4. In FIG. 8, it is seen that the intercept grows to be unrealistically large and biased in magnitude in the 7th iteration and the learning actually failed to converge in the critical 8th and 9th iterations. Often, there will be convergence when the intercept grows to a large value, but the problem is that regression coefficients in selected features are also biased to be unrealistically large in magnitude. Keeping the intercept in the training may not have substantial effects on the ultimate selected best learning solution even in a completely balanced sample with larger numbers of optimally selected features as typically occurs in the optimal Implicit RELR learning. This is because RELR learning has few convergence problems relative to standard logistic regression with balanced target outcomes with larger numbers of selected features, and a best learning can be simply defined to be the best learning where convergence is reached in Implicit RELR. Yet, this example in FIG. 7 and FIG. 8 shows that this scenario of balanced binary target outcome samples with a zero intercept can cause bias problems and convergence failures with smaller numbers of features which is expected to be the actual estimated optimal solution often in Explicit RELR. So, removing the intercept in a balanced binary outcome sample and then correcting the intercept post-training should be considered a mandatory practice in Explicit RELR.

In summary, once the larger candidate feature set is reduced into a more manageable smaller feature set using the U.S. Pat. No. 8,032,473 invention mechanism that 1) chooses features with the largest t-value magnitudes used in the error probability learning, and 2) where the target and non-target outcome samples in a binary target are stratified to be perfectly balanced prior to computing the t-values so that these are not dependent upon the choice of the t-value statistic used except in rare cases with missing data in which case the bias will still be minimized due to the balancing, and 3) which handles even and odd polynomial features separately to avoid bias, this newly invented explicit feature selection process that is called Explicit RELR may be outlined as:

1) Generate training with a missing intercept in the case of a binary target where the sample is stratified so that there are perfectly balanced binary outcomes, but which has intercepts present and requires no such stratification in the case of ordinal outcomes, using the previously patented RELR learning procedure which simply generates a maximum likelihood/maximum entropy solution based upon standard optimization procedures such as standard gradient ascent methods to generate an optimal solution to Equation 1.1a or equivalently Equation 1.1 and all its associated constraints including the error probability learning constraints that uniquely characterize the RELR machine learning method.

2) Across all features included in the solution to Step 1, compute the Explicit RELR feature importance value defined as Equation (1.16).

3) Drop the feature that has the lowest magnitude Explicit RELR feature importance value.

4) Go back to Step 1 until no more features remain.

5) Amongst all previously computed feature selection solutions in the previous steps, choose the best Explicit RELR learning to be that which has the largest RLL value as defined in Equation (1.1a) where we also remember to correct the intercept after this best learning is chosen in the case of binary or two category ordinal/interval categorized logistic regression in accord with commonly used intercept correction in logistic regression.

One further caveat here applies to special case where prior weights are used from previous historical data to determine learning over time in RELR. In this special case, the βᵣ parameter that is used to construct the feature importance in Step 3 may be a sum of both the prior and the update weight parameters.

Handling of Perfect Positive or Negative Correlations

In the case where rr equals 1 or −1, a best practice in the previously patented RELR method was to adjust the correlation to be approximately 1 or −1 like a value of 0.99 or −0.99 so that division by zero does not occur in Equations (1.5a) and (1.5b). Perfect positive or negative correlations are extremely unlikely in real world data that are not completely deterministic with sample sizes above a minimum. In general, sample sizes used in RELR are advised to be large enough so that t-values are reliable. The sample size required for t-values to be reliable is data dependent, but in many application fields this is often viewed as roughly 15-30 in each binary target or ordinal category group whereas the number may be less with more deterministic data. Hence, provided that features with extremely small samples in one or more groups are excluded as candidates for important features in RELR, perfect positive or negative correlations between features and the target variable will be unlikely but if they occur in larger samples they can be viewed as reliable and good predictors. So a value of 0.99 or −0.99 or a similar value close to 1 or −1 will be a good estimate of the correlation in the population if it is observed to be a perfect correlation in a large enough sample.

However, with very small samples used to define the correlations and t-ratios that encompass Equations (1.5a) and (1.5b), perfect positive or negative correlations may occur more frequently especially when there are large numbers of missing values in predictor variable features that are correlated with the target variables. In this case, the choice of something like 0.99 or −0.99 to replace a perfect correlation of 1 or −1 and avoid division by zero in these equations can have a large and biased effect, as a different choice like say 0.999 or −0.999 may have a very different effect on the error probability estimates that leads to very different RELR solutions. So a reliable mechanism is needed to avoid this arbitrary choice or another arbitrary choice such as excluding features which have below a minimal number of non-missing observations.

In this current invention, a very simple automatic mechanism is utilized. In any case where a perfect positive or negative correlation is observed, one randomly chosen observation's target outcome value is randomly changed to the average of the original value and the next closest target outcome category value only for the purpose of calculating error probability learning parameters from these equations of 1.5a and 1.5b that avoid division by zero. So, with a binary target or ordinal outcome variable with two categories, a random observation selection is performed and the selected observation's target outcome value is changed from 0 to 0.5 or from 1 to 0.5 depending upon the original value. With an ordinal target variable with more than two categories, the original value is changed to the average of the original rank value for a category and the closest ordinal target variable value in terms of rank, and randomization is used to break any ties; these considerations are not necessary for the case of just two categories in the target outcome variables. This mechanism is only done for the purpose of avoiding perfect correlations in the error probability learning calculations, as these changed values are not used in the actual RELR learning which can handle perfect correlations. Here is a simple example that shows the effectiveness of this mechanism. In a case with just two ordinal categories as in a binary target outcome and binary predictor each with 6 observations (half 0 and half 1) and a perfectly positive correlation, randomly changing one observation's target variable value leads to a correlation of 0.918. With 30 similarly balanced and perfectly correlated observations, it leads to a correlation of 0.983. With 100 similarly balanced and perfectly correlated observations, it leads to a correlation of 0.995. Thus, the correlations which are more likely to be unreliable because they are based upon very small sample observations will tend to be of smaller magnitude with this new mechanism, but the correlations based upon larger sample observations which are reliably near perfect will still have large and near perfect correlations.

Although the invention has been explained in relation to its preferred embodiment, it is to be understood that many other possible modifications and variations can be made without departing from the spirit and scope of the invention.

What is claimed is:

1. A system for machine learning comprising: a computer including a computer-readable medium having software stored there on that, when executed by said computer, performs a method comprising the steps of being trained to learn a reduced error logistic regression match to a target category variable and to exhibit learning by which the reduced error logistic regression method is improved with a mechanism where ordinal target variable outcomes with more than two categories are treated by using the same mechanism involving only two categories in the error modeling as is used with just two ordinal target variable categories;

2. The system of claim 1 with an explicit feature selection learning mechanism which has a zeroed intercept in the case of where the training sample is stratified so that there is an ordinal target variable for prediction with only two perfectly balanced ordinal target outcome categories, but which has intercepts present in the case of ordinal target outcomes with more than two categories, and which computes across all features in a solution with the Explicit RELR feature importance value defined as Equation 1.16, and which drops the feature that has the lowest magnitude Explicit RELR feature importance value, and which continues this recursive process of building a solution with remaining features and dropping the feature with the lowest feature importance magnitude until no more features remain and which then chooses amongst all previously computed feature selection solutions the best Explicit RELR learning to be that which has the largest RELR Log Likelihood value as defined in Equation (1.1a) where the intercept is corrected after this in the case of only two target categories in accord with standard method used for logistic regression.

3. The system of claim 2 with a mechanism to avoid perfect Pearson correlations between predictor features and the target outcome that result in division by zero in its RELR error probability learning parameters by randomly selecting one observation and changing its target outcome value to an average of this outcome's original target category value and the value of the next closest outcome category in terms of ranked values only for the purpose of calculating the t-values that are necessary to compute the error probability learning parameters;
